(19) United States
(12) Patent Application Publication
(10) Pub. No.: US 2026/0368214 A1
(43) Pub. Date: Nov. 19, 2026

(54) DYNAMIC REFINEMENT OF LANGUAGE MODEL EVALUATION CHECKLISTS

(71) Applicant: Microsoft Technology Licensing, LLC, Redmond, WA (US)

(72) Inventors: Sumit GULWANI, Sammamish, WA (US); Mukul SINGH, Seattle, WA (US); Mansi UNIYAL, Ghaziabad (IN); Vu Minh LE, Redmond, WA (US); Gust Ben Anneloes VERBRUGGEN, Keerbergen (BE)

(21) Appl. No.: 19/210,477

(22) Filed: May 16, 2025

(51) Int. Cl. G06F 16/3329; G06F 40/18

(52) U.S. Cl. CPC G06F 16/33295; G06F 40/18

(57) ABSTRACT

Technology disclosed herein pertains to the dynamic refinement of evaluation checklists for language models. An evaluation system generates a prompt including an evaluation checklist and a generated content item. The evaluation checklist includes predefined evaluation questions for a language model to answer with respect to the generated content item and an option for the language model to generate a free-form response. The system sends the prompt to the language model to obtain an evaluation of the generated content item based on the evaluation checklist and receives a response from the language model. The response includes answers to the predefined evaluation questions and at least one free-form response indicating a characteristic of the generated content item. The system also updates the evaluation checklist with a new evaluation question based at least on the at least one free-form response.

### TECHNICAL FIELD

Aspects of the disclosure are related to the field of computer hardware and software and, in particular, to evaluation checklists used by language models.

### BACKGROUND

Large language models (LLMs) are widely used for generating and processing natural language across various applications, including text summarization, translation, question answering, content creation, and the like. These models rely on deep neural networks trained on vast amounts of text data to predict and generate responses. Evaluating the accuracy and quality of LLM-generated outputs, however, remains a challenge, as traditional evaluation metrics primarily rely on lexical overlap rather than semantic understanding. As a result, human annotation is often required to assess model performance, which is costly, time-consuming, and prone to inconsistencies.

To mitigate reliance on human evaluators, LLMs themselves have been used as judges to assess the quality of generated outputs by comparing them to reference materials or predefined criteria. However, this approach also faces several issues, including model bias, sensitivity to prompt phrasing, and inconsistencies in evaluation across different runs. Additionally, LLMs often lack transparency in their assessments, making it difficult to interpret or validate their judgments. These challenges complicate the development of reliable, automated evaluation systems that can consistently measure the quality of LLM-generated content without requiring extensive manual oversight.

Existing methods attempt to improve evaluation using structured frameworks such as scoring rubrics, predefined rule-based systems, or checklist-based assessments. While these techniques provide more structured and interpretable evaluations, they require significant manual effort to design and maintain, particularly as new types of errors emerge over time. Furthermore, these frameworks often struggle to comprehensively capture all potential issues in generated content, leading to gaps in evaluation coverage. As LLMs continue to evolve, there remains a need for more adaptable and scalable evaluation systems that can address these limitations.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

Technology disclosed herein pertains to the refinement of evaluation checklists for using large language models (LLMs) as judges. More specifically, the present technology uses checklists with predefined evaluation questions and a free-form response option to dynamically update and improve evaluation criteria. In various embodiments, an evaluation system implemented in program instructions executed by processing circuitry on a computing platform or apparatus generates a prompt including an evaluation checklist and a generated content item. The evaluation checklist includes predefined evaluation questions for a language model to answer with respect to the generated content item and an option for the language model to generate a free-form response. The system sends the prompt to the language model to obtain an evaluation of the generated content item based on the evaluation checklist and receives a response from the language model. The response includes answers to the predefined evaluation questions and at least one free-form response indicating a characteristic of the generated content item. The system also updates the evaluation checklist with a new evaluation question based at least on the at least one free-form response.

Overall, this approach improves the accuracy, adaptability, and completeness of LLM-based evaluations by dynamically refining checklists, reducing bias, and improving the interpretability of assessment criteria. This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a computing environment in accordance with some embodiments of the present technology.

FIG. 2 is a flowchart illustrating a series of steps performed by a developer application in accordance with some embodiments of the present technology.

FIGS. 3A-3B are sequence diagrams illustrating a series of steps performed in an implementation with respect to the computing environment of FIG. 1 and the flowchart of FIG. 2.

FIG. 4 illustrates a content evaluation and checklist updating process in accordance with some embodiments of the present technology.

FIG. 5 is a flowchart illustrating a series of steps for updating a checklist performed at least in part by a language model in accordance with some embodiments of the present technology.

FIG. 6 is a flowchart illustrating a series of steps for run-time content evaluation performed at least in part by a language model in accordance with some embodiments of the present technology.

FIG. 7 illustrates content generation in the context of a user experience in accordance with some embodiments of the present technology.

FIG. 8 illustrates a computing system suitable for implementing the various operational environments, architectures, processes, scenarios, and sequences discussed below with respect to the other Figures.

### DETAILED DESCRIPTION

Technology disclosed herein pertains to the refinement of evaluation checklists for using large language models (LLMs) as judges. More specifically, the present technology uses checklists with predefined evaluation questions and a free-form response option to dynamically update and improve evaluation criteria. In various implementations, disclosed methods include generating a prompt with an evaluation checklist and a generated content item. The checklist includes a set of predefined evaluation questions for an LLM to answer with respect to the generated content item and an option for the LLM to generate a free-form response in addition to answering the predefined questions. The disclosed methods further include sending the prompt to the LLM to obtain an evaluation of the generated content item based on the checklist and receiving a response from the LLM. The response includes the LLM’s answers to the predefined questions and at least one free-form response indicating a characteristic of the generated content item not addressed by the predefined questions. The disclosed methods further include updating the evaluation checklist with a new evaluation question based on the at least one free-form response.

Subjective evaluation of language model outputs presents significant challenges in artificial intelligence (AI) development workflows. Traditional evaluation methods rely heavily on human annotation, which is resource-intensive, time-consuming, and often inconsistent due to subjective interpretation. Existing automated metrics provide quantitative assessment but lack semantic understanding and contextual awareness. Recent advancements have enabled the use of LLMs as evaluators of content generated by language models. However, this approach faces several technical limitations: LLMs exhibit inherent biases toward content they themselves generate, lack transparency in scoring methodologies, and provide inconsistent judgments without adequate explanation. These challenges are particularly pronounced in development environments for spreadsheet applications where natural language explanations of formulas, data analysis results, and other technical content must be evaluated against multiple quality criteria simultaneously.

The technology disclosed herein addresses these limitations through an automated system for refining evaluation checklists used when LLMs act as judges for evaluating content quality. The system includes a structured evaluation framework that decomposes subjective assessment into discrete, measurable criteria organized as checklist questions. Instead of relying on open-ended quality assessment, the invention implements a checklist-based approach that yields more reliable, interpretable, and reproducible results. The systems and methods of the present disclosure introduces a free-form comment option alongside standard checklist questions, enabling the language model to identify evaluation criteria not explicitly covered by existing checklist items. These comments are systematically processed to generate new evaluation questions, which can then be incorporated into an evolving checklist that continually improves in completeness and accuracy.

In some implementations, the disclosed system operates within a computing environment optimized for developer workflows in spreadsheet application development. The architecture includes a user application interface, a developer application interface, a database system for storing generated content, and integration with one or more language models. The developer application serves as the primary control interface, allowing developers to manage evaluation checklists, review judgments, and approve updates to the evaluation criteria based on free-form comments generated during the assessment process. The database system may also maintain versioned checklists, enabling lineage tracking and performance comparison across different checklist iterations.

An operational workflow in accordance with the system disclosed herein begins with generating a prompt that incorporates the evaluation checklist, a generated content item to be evaluated, and the free-form response option. This prompt is sent to the language model, which then produces structured answers to the predefined checklist questions along with free-form comments regarding aspects not covered by the existing checklist. These responses are received and subsequently used to update the evaluation checklist. The workflow encompasses three distinct processes: (1) checklist-based evaluation with free-form comment collection, (2) aggregation of comments into candidate checklist questions, and (3) pruning of redundant or overlapping criteria from the updated checklist. This workflow enables continual refinement where the evaluation framework evolves to address previously unidentified quality criteria, particularly for specialized domains such as spreadsheet formula explanations and data analysis interpretations.

In some implementations, the disclosed system leverages one or more cloud-hosted language models with in-context learning capabilities to process complex evaluation prompts. In-context learning allows for flexible response to evolving checklist questions without requiring model retraining. The evaluation checklist itself may be stored as a simple data structure (e.g., JSON format) within a database. In some embodiments, each checklist is domain-specific, focusing on particular functionality areas such as formula explanations or data analysis interpretations (e.g., within the spreadsheet application environment). The system processes input that includes the checklist and the evaluation dataset through the language model and generates structured answers and free-form comments. These outputs undergo aggregation to identify recurring patterns and pruning to eliminate redundancy, resulting in refined evaluation criteria that more comprehensively capture quality dimensions relevant to spreadsheet application functionalities.

Various technical effects may be appreciated from the implementations disclosed herein. The incorporation of free-form comment capabilities alongside structured checklist questions significantly improves the completeness and accuracy of language model evaluation processes, yielding substantial computational efficiencies. By decomposing subjective assessments in discrete evaluation criteria that evolve through systematic feedback mechanisms, the system reduces computational overhead associated with redundant LLM inference calls. This adaptive evaluation framework minimizes false negative evaluations where valid content is incorrectly flagged due to inappropriate assessment criteria, and false positive evaluations where problematic content passes assessments due to incomplete quality metrics. The implementation of aggregation and pruning mechanisms prevents checklist bloat, maintaining evaluation efficiency while providing comprehensive coverage of potential quality dimensions. Additionally, the system enhances developer productivity by automating the labor-intensive process of evaluation framework design, reducing the number of manual iterations required to establish robust quality metrics. Furthermore, the approach improves evaluation consistency across multiple iterations by maintaining a persistent, systematically refined evaluation framework that captures domain-specific quality considerations with increasing precision over time.

The incorporation of free-form comment capabilities alongside structured checklist questions improves the accuracy of responses to the original checklist questions themselves. When a language model evaluates content against a fixed checklist without an outlet for additional observations, it may force categorization of identified issues into existing checklist criteria even when no precise match exists. This forced categorization reduces evaluation accuracy by creating false associations between observed issues and available criteria. The free-form comment mechanism eliminates this constraint by providing the model with a dedicated pathway for observations that fall outside existing evaluation dimensions. Technical testing demonstrates that this architectural modification allows the language model to maintain higher precision when responding to the original checklist questions, as it no longer needs to artificially cluster diverse issues into predetermined categories. This represents a measurable technical improvement in evaluation accuracy independent of the checklist refinement benefits.

In one use case, the evaluation system disclosed herein enables systematic refinement of formula explanations produced by an AI assistant in the context of a user-facing spreadsheet application. When developers evaluate the performance of the AI assistant, the free-form comment mechanism captures nuanced issues such as incomplete argument explanations or inadequate contextual relationships between formula components. These captured insights may be transformed into structured evaluation criteria that measurably improve subsequent formula explanations. Through this adaptive evaluation process, the formula explanation capabilities may evolve to handle edge cases and specialized functions with increasing precision, directly enhancing end-user productivity through more accurate and complete formula comprehension.

For example, the disclosed system may enable domain-specific optimization of AI assistants in spreadsheet applications by identifying and incorporating evaluation dimensions uniquely relevant to spreadsheet data analysis workflows. When analyzing evaluation results from a financial modeling scenario, the system may capture repeated free-form comments about insufficient explanations of calculation assumptions or inadequate clarification of dependency relationships between calculated values. This specialized feedback transforms into tailored checklist questions (e.g., “Does the explanation clarify which cells influence the calculation?” or “Are formula precedents and dependents adequately described?”) that progressively enhance the AI assistant’s ability to provide contextually appropriate explanations for domain-specific analyses. The resulting domain-optimized evaluation framework thus helps AI capabilities (e.g., within a spreadsheet application) evolve to match user expectations across specialized use contexts.

While many examples throughout this specification are given in the context of productivity applications (e.g., spreadsheet applications) and AI-powered productivity tools, the disclosed system applies across a range of diverse domains that may benefit from systematic evaluation of language model outputs. The methodology of capturing free-form comments to evolve evaluation frameworks can enhance technical implementations in domains including code generation assessment, technical documentation authoring, API response evaluation, summarization quality measurement, translation accuracy verification, conversational agent development, and many more. This technical approach addresses the universal challenge of establishing comprehensive evaluation criteria for unstructured content generation across computational systems where complete enumeration of quality dimensions may be difficult to predetermine.

Although the implementation examples primarily reference large language models (LLMs), the evaluation framework disclosed herein is applicable across various language model architectures. For example, this disclosed approach may be implemented with small language models (SLMs), retrieval-augmented generation systems, multi-modal language models, domain-adapted foundation models, ensemble language processing frameworks, and more. The system’s design remains effective regardless of the underlying language model implementation, provided the model possesses sufficient contextual understanding capabilities to process structured evaluation criteria and generate meaningful free-form responses identifying unanticipated evaluation dimensions.

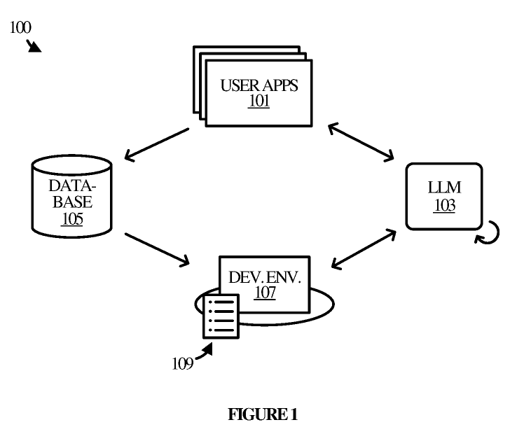

FIG. 1 illustrates system 100 in an implementation. System 100 provides a comprehensive framework for content generation and evaluation, integrating various components to facilitate checklist-based evaluation and improvement. System 100 includes user applications 101, LLM 103, database 105, developer environment 107, and checklist 109. The elements of FIG. 1 may interact through various data flows to facilitate the evaluation and improvement of language model generated content. The elements depicted in FIG. 1 are presented solely for purposes of example, and system 100 may include additional, fewer, or alternative elements than those illustrated in the example of FIG. 1.

User applications 101 represents one or more client-side software components through which end users may interact with LLM 103, typically submitting prompts and receiving generated content. User applications 101 may include spreadsheet applications, word processing applications, browser applications, productivity tools, or other software incorporating AI assistance capabilities. User applications 101 operate on one or more computing devices of various form factors and processing architectures. Specifically, user applications 101 may execute on desktop computing systems, laptop computers, tablet devices, mobile smartphones, thin clients, or specialized workstations depending on deployment context, as just a few examples. User applications 101 may support both local installation models and web-based delivery mechanisms that operate within browser environments. In enterprise settings, user applications 101 may be deployed across managed device fleets with centralized configuration policies, while individual users may access the application(s) through personal devices with localized settings. The application(s) may connect to LLM 103 through various network protocols including secure HTTPS connections, WebSocket implementations, or proprietary API interfaces, enabling real-time interaction regardless of the underlying hardware platform.

LLM 103 represents one or more LLMs deployed in a cloud-based environment or other computational infrastructure. LLM 103 processes user prompts in the form of text strings from user applications 101 to generate content responses in the form of text strings and also serves as the evaluation engine when operating on content with checklist 109. LLM 103 may be provisioned as a managed service within one or more cloud platforms, deployed within containerized environments using orchestration frameworks, or instantiated across hybrid architectures that combine on-premises high-performance computing clusters with cloud-based resources, as just a few examples. In enterprise deployments, LLM 103 may operate within dedicated computational instances with hardware acceleration via specialized processing units including GPUs, TPUs, or purpose-built AI accelerators to optimize inference performance.

LLM 103 may be implemented using various types of machine learning models, including but not limited to transformer-based neural networks, recurrent neural networks (RNNs), convolutional neural networks (CNNs), or hybrid architectures combining multiple techniques. LLM 103 may be trained using supervised learning, unsupervised learning, reinforcement learning, or a combination thereof, and may utilize techniques such as transfer learning, fine-tuning, or prompt engineering to optimize performance for specific applications.

LLM 103 processes user prompts from user applications 101 to generate content responses and also serves as the evaluation engine when operating on content with checklist 109. The bidirectional arrows between LLM 103 and user applications 101, as well as LLM 103 and developer environment 107, indicate the dual functionality of LLM 103 in both generating content and evaluating that content against defined criteria, with internal routing mechanisms directing requests to appropriate model instances or parameter configurations based on the intended processing pathway. Regardless of the specific physical deployment, LLM 103 maintains consistent computational capabilities through standardized API interfaces, authentication mechanisms, and request handling protocols.

While FIG. 1 depicts LLM 103 as a single element responsible for both generating content and evaluating generated content items, in other embodiments, these tasks may be performed by separate and distinct LLMs. Employing multiple specialized LLMs allows for optimized performance and tailored functionality. For instance, one LLM may be fine-tuned for content generation within the spreadsheet application domain, while another LLM may be specifically trained to assess and provide feedback on the quality of generated content. Furthermore, LLM 103 may encompass an ensemble of models working in concert, each focusing on different aspects of the generation and evaluation process, such as language understanding, context analysis, and quality assessment.

Database 105 is representative of a storage component that stores generated content items, and may additionally store evaluation checklists, evaluation results, or other historical data. Database 105 may provide persistent storage for tracking checklist evolution over time and storing content items that require evaluation. Database 105 may be implemented as a flexible storage architecture implemented through various technologies including but not limited to relational databases, NoSQL solutions, object storage, distributed file systems, or the like, and may be deployed either as dedicated instances of integrated within existing infrastructure. Implementation options range from high-performance configurations with in-memory caching tiers for frequently accessed data to cost-optimized architectures with automated transitions to cold storage for historical records. Database 105 may incorporate comprehensive versioning mechanisms tracking checklist evolution, capturing incremental modifications, question refinements, and associated metadata to enabled detailed lineage analysis and selective rollback capabilities when needed.

The generated content items maintained in database 105 include outputs of LLM 103 produced in response to user prompts from one or more applications of user applications 101. In the context of a spreadsheet application, the generated content items may include natural language explanations (i.e., text strings) of spreadsheet formulas, data analysis results, procedural instructions for data analysis workflows, narrative summaries of tabular data visualizations, contextual descriptions of calculation methodologies, formula recommendations with accompanying rationales, and the like. In some examples, ach content item is stored with associated metadata that may include generation parameters, prompt context, timestamp information, and relational linkages to evaluation results.

Developer environment 107 represents the administrative interface through which developers manage the evaluation framework. Developer environment 107 includes one or more applications that interface with both database 105, LLM 103, and user applications 101, enabling developers to configure evaluation parameters, review evaluation results, and approve updates to checklist 109. Developer environment 107 may represent a comprehensive administrative platform through which engineering teams orchestrate evaluation framework configuration, monitor assessment metrics, and implement systematic checklist refinement procedures. Developer environment 107 provides functionality for checklist management, including but not limited to: (1) initializing evaluation checklists with domain-specific questions, (2) reviewing and approving proposed checklist modifications generated from free-form responses, (3) manually editing or refining automated question suggestions before implementation, (4) comparing checklist versions to assess evaluation evolution, and (5) exporting finalized checklists for deployment within production environments.

Developer environment 107 may be deployed across various computing environments including dedicated engineering workstations, virtual development environments, containerized instances within continuous integration/continuous deployment (CI/CD) pipelines, and/or browser-based administration portals accessible through authenticated sessions. The implementation architecture supports both thick-client deployments with local processing capabilities and thin-client configurations where computational processing occurs server-side with results rendered through lightweight front-end frameworks. Developer environment 107 may establish bidirectional communication channels with database 105 through optimized query interfaces that support both transactional operations and analytical processing workloads. Developer environment 107 may communicate with LLM 103 via standardized API protocols with appropriate rate limiting, authentication mechanisms, request prioritization, and the like. Via developer environment 107, developers may configure evaluation parameters, define checklist states, establish aggregation criteria for redundant comments, implement pruning thresholds, review evaluation results, and execute controlled deployment of checklist refinements with appropriate approval workflows and versioning controls.

Checklist 109 represents a structured data element that includes discrete evaluation criteria for assessment of language model outputs through decomposed quality dimensions. Checklist 109 may be stored in formats including but not limited to JSON, XML, or YAML. Checklist 109 contains questions that decompose subjective assessment of generated content items into discrete, measurable dimensions, along with a free-form comment option to capture quality considerations not covered by the existing checklist questions.

Checklist 109 includes questions designed to assess the quality, accuracy, and effectiveness of the content generated within the context of user applications 101. These questions aim to determine how well the generated content aligns with the user’s requirements and expectations, and may focus on aspects such as clarity, accuracy, completeness, relevance, conciseness, actionability, and formatting. For instance, checklist 109 may include questions that evaluate whether the generated content is easily understandable for the intended audience, using appropriate language and minimizing technical jargon. The checklist may also assess the accuracy of the content, verifying that it correctly reflects the underlying data, formulas, or analysis results without any errors or inconsistencies. Additionally, the checklist may examine the completeness of the generated content, checking that it provides a comprehensive explanation or description of the relevant information without omitting important details.

Furthermore, one or more questions within checklist 109 may address the relevance of the generated content to the user’s specific query or spreadsheet task, confirming that it addresses the key aspects of the problem or scenario at hand. The questions may also assess the conciseness of the content, verifying that it conveys the necessary information without unnecessary details or redundant information. Moreover, checklist 109 may evaluate the actionability of the generated content—determining whether it provides practical insights or guidance that users can easily understand and apply to their task.

Questions of checklist 109 may further consider the formatting and structure of the generated content, assessing whether it employs appropriate headings, bullet points, or other visual elements to enhance readability and comprehension.

The arrows between components of FIG. 1 illustrate data flows within system 100. Content generated through user applications 101 flows to database 105 for storage and to developer environment 107 for evaluation. One or more applications of developer environment 107 retrieve generated content from database 105, construct evaluation prompts incorporating checklist 109, and send these to LLM 103 for assessment. LLM 103 returns evaluation results to developer environment 107, which processes free-form comments to update checklist 109 as appropriate.

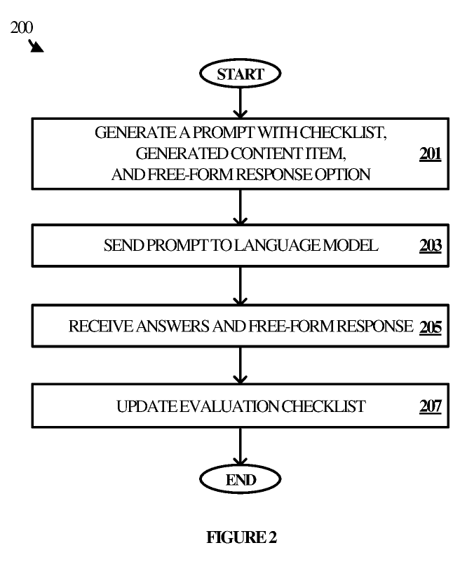

FIG. 2 illustrates process 200. Process 200 is an exemplary operation of dynamic checklist refinement for language model-based evaluation in the context of system 100. The operations may vary in other examples. The operations of process 200, in some examples, are performed within one or more applications of developer environment 107 in the example of FIG. 1. Process 200 may be implemented in program instructions in the context of the software and/or firmware elements of developer environment 107. The program instructions, when executed by one or more processing devices of one or more suitable computing devices, direct the one or more computing devices to operate as follows, referring to the steps of FIG. 2 and in the singular to a computing device for the sake of clarity.

In operation, the computing device generates a prompt with at least a checklist, a generated content item, and a free-form response option (step 201). The checklist includes predefined evaluation questions for a language model to answer with respect to the generated content item. The checklist further includes the option for the language model to generate a free-form response in addition to answering the predefined evaluation questions. In the example of FIG. 1, developer environment 107 generates a prompt with checklist 109 and at least one generated content item from database 105. Checklist 109 includes a free-form response option in addition to the predefined evaluation questions.

The computing device sends the generated prompt to a language model for evaluation of the generated content item based on the checklist (step 203). In the example of FIG. 1, developer environment 107 sends the generated prompt, including checklist 109 and at least one generated content item from database 105, to LLM 103 for evaluation. In response to receiving the prompt, the language model processes the prompt and evaluates the quality and characteristics of the generated content item based on the predefined questions in checklist 109 and then adds one or more comments about issues with the generated content item that are not addressed by the questions. If no unaddressed issues exist, the language model does not add a free-form response despite having the option to do so.

The computing device then receives a response from the language model (step 205). The response includes the language model’s answers to the predefined evaluation questions and at least one free-form response. In the example of FIG. 1, developer environment 107 receives the answers and at least one free-form response from LLM 103. The free-form response provides additional insights or feedback on the generated content item that may not be captured by the predefined questions alone. Via the free-form response, the language model may highlight notable aspects, strengths, weaknesses, or areas for improvement that the predefined questions might not directly address.

Upon receiving the language model’s response, the computing device updates the evaluation checklist based on the at least one free-form response (step 207). In the example of FIG. 1, developer environment 107 updates the evaluation checklist based on the at least one free-form response received from LLM 103. Updating the checklist involves analyzing the free-form feedback provided by the language model and identifying recurring themes, patterns, or insights that could enhance the evaluation process. In some implementations, developer environment 107 utilizes LLM 103 for help in updating the checklist, such as by assigning LLM 103 with the task of updating the checklist based on the free-form response to add a question, aggregate redundant questions, prune questions from the list, or the like. The computing device (and/or the LLM) then generates one or more new evaluation questions that capture these key points and adds them to the existing checklist. The specific updating process may include: (1) extracting evaluation criteria from the free-form responses, (2) formulating these criteria as discrete evaluation questions compatible with the existing checklist format, (3) determining appropriate placement within the checklist structure, and (4) implementing the addition while maintaining overall checklist coherence.

Process 200, which includes generating a prompt, sending it to the language model for evaluation, receiving a response, and updating the checklist, can be repeated iteratively to allow for continual refinement of the evaluation framework. Iterative performance of this process allows for continual improvement of the checklist as the language model encounters new types of generated content or identifies additional areas for assessment. These iterations may involve multiple evaluations of different content items over time, allowing the system to accumulate a diverse set of free-form responses across various content types, use cases, and quality dimensions. Multiple evaluations may enable the system to identify patterns that might not be apparent from a single evaluation cycle, providing a more comprehensive basis for checklist refinement. For example, a particular issue might appear rarely in individual content items but become statistically significant when observed across multiple evaluations of dozens or hundreds of items, warranting the addition of a new evaluation question to address this recurring pattern.

Technical benefits of the free-form comment option may be illustrated through specific operational examples in the context of spreadsheet application formula explanations and instructions. In an example, an evaluation involves the query “Heighlight value where it is greater than 3 on G9:G17 on Sheet1,” which is to be checked against a checklist question, “Does the input query avoid ambiguous language, jargon, or terms that could be interpreted in multiple ways?” Without the free-form comment option, the LLM may answer “no” to the question, incorrectly categorizing a typographical error (“heighlight” instead of “highlight”) as ambiguous language or jargon. When equipped with the free-form comment option, however, the language model is more likely to correctly answer “yes” to the checklist question while separately noting “the term ‘heighlight’ appears to be a typographical error and should likely be ‘highlight.’” In another example, an evaluation involves the query “In Calc sheet, Apply color scale from C36 to C 39,” which is to be evaluated against checklist question “Does the input query ensure that cell ranges are specified in a logical order?” Without the comment option, the model may answer “no.” With the comment option, however, the model is more likely to correctly answer “yes” while noting “the input query has an inconsistent cell reference format (‘C36 to C 39’ should be ‘C36 to C39’).” These examples demonstrate how the free-form comment option enables more precise evaluation by decoupling issue identification from checklist categorization, yielding more accurate and interpretable assessment outcomes.

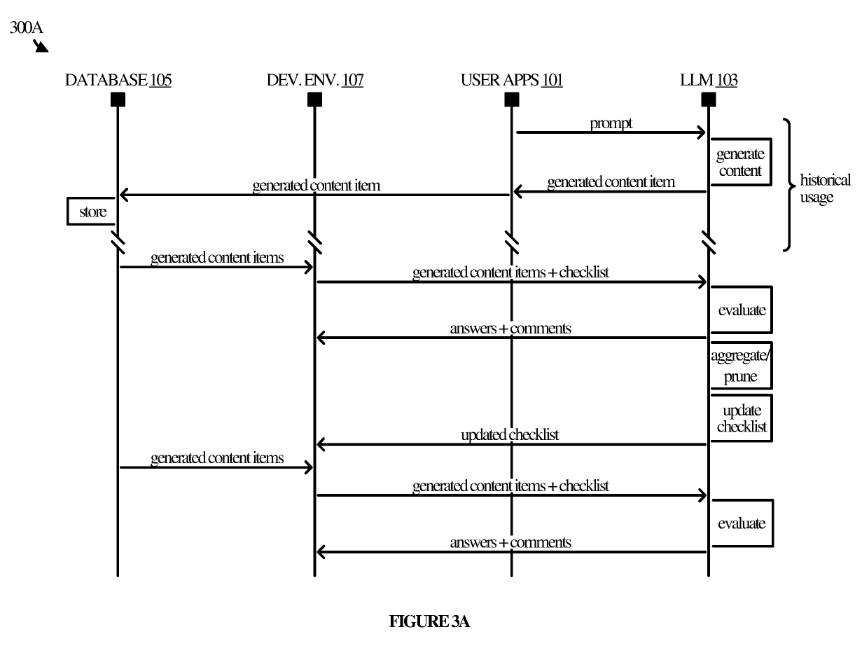

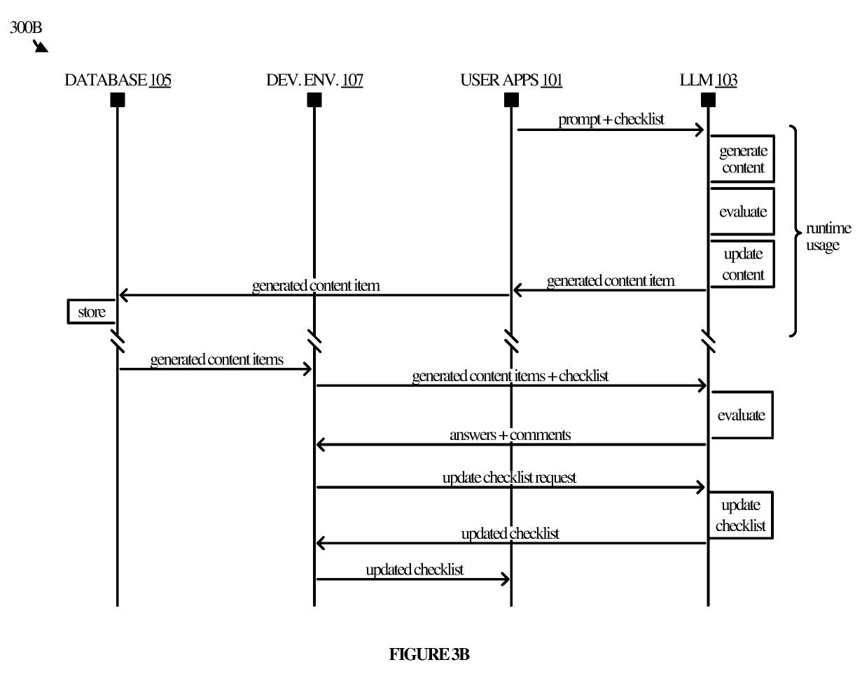

FIG. 3A illustrates operational scenario 300A, which depicts an application of the content evaluation process described with respect to the elements and dataflows of system 100 and process 200. Operational scenario 300A involves the interaction between a user application of user applications 101, database 105, developer environment 107, and LLM 103.

The user application of user applications 101 generates a prompt based on a user query or request for assistance. The prompt is sent to LLM 103, which processes the prompt and generates a response. The generated content item may include one or more natural language responses, explanations, or guidance related to the functionality and usage of the application. In general, the generated content item is a text string that uses natural language to explain something. For example, if the user application is a spreadsheet application, a user might ask for help writing a formula to calculate profit based on a data table within the spreadsheet. LLM 103 would then generate a content item that provides a relevant explanation or step-by-step instructions to assist the user in implementing such a formula.

Generated content items produced by LLM 103 are stored in database 105. Database 105 serves as a repository for the generated content items, making them accessible for subsequent evaluation and analysis within developer environment 107. Developer environment 107 retrieves a set of generated content items from database 105 and submits them with an evaluation checklist as an evaluation prompt. The evaluation checklist includes predefined questions designed to assess the quality and effectiveness of the generated content items. Additionally, the evaluation checklist includes a free-form response option, allowing LLM 103 to provide additional insights or feedback beyond the predefined questions.

The computing device running developer environment 107 sends the prompt, which includes the generated content items and the evaluation checklist, to LLM 103 for evaluation. LLM 103 processes the prompt and generates responses that include answers to the predefined questions in the checklist and free-form comments. The free-form comments provide additional insights, observations, or suggestions for improvement regarding the generated content items.

Developer environment 107 receives the evaluation responses from LLM 103, which include the answers to the checklist questions and the free-form comments for each generated content item. In the example of FIG. 3A, LLM 103 also performs an aggregation and pruning process on the free-form comments, which involves analyzing the comments to identify recurring themes, patterns, or actionable insights. Based on this analysis, LLM 103 generates new evaluation questions that capture the key points raised in the free-form comments. These new questions are then added to the evaluation checklist. LLM 103 may also remove questions from the evaluation checklist during the pruning and/or updating steps.

After receiving the updated checklist from LLM 103, developer environment 107 initiates another evaluation cycle. Developer environment 107 retrieves a new set of generated content items from database 105 and applies the updated checklist to assess their quality. Developer environment 107 submits the new set of generated content items with the updated checklist for evaluation by LLM 103. LLM 103 evaluates the generated content items using the new set of questions in the checklist, provides answers to the new questions, and generates new free-form comments if applicable. The evaluation results, including the checklist answers and comments, are returned to developer environment 107.

It should be noted that while the updated checklist does not directly affect the content generation process in this specific scenario, the evaluation results and free-form responses provided by LLM 103 may be used for future training and refinement of LLM 103 itself. By analyzing the evaluation outcomes and incorporating the insights from the free-form comments, developers can identify areas for improvement in LLM 103’s content generation capabilities within the context of each user application of user applications 101.

FIG. 3B illustrates operational scenario 300B, which depicts an alternate application of the content evaluation process described with respect to the elements and dataflows of system 100 and process 200. Operational scenario 300B involves the interaction between user applications 101, database 105, developer environment 107, and LLM 103.

In operational scenario 300B, a user application of user applications 101 generates a prompt containing both a user query and an evaluation checklist. This checklist includes predefined criteria for assessing the generated content item. The prompt and checklist are transmitted to LLM 103, which processes the input and generates a response. The generated response may include a natural language response, explanation, or other form of output relevant to the user’s request. For example, if the application is a coding assistant, a user might request guidance on debugging a script, and LLM 103 would generate a response detailing potential issues and debugging techniques.

After generating the content item, LLM 103 submits the generated content item, along with the checklist, for evaluation. The evaluation process involves LLM 103 responding to the predefined checklist questions and providing free-form comments regarding the generated content item. The free-form comments may highlight issues that are not directly addressed by the checklist or provide additional observations.

Based on the evaluation results, LLM 103 updates the generated content item before finalizing it for the user. If the evaluation indicates areas for improvement, LLM 103 re-writes or refines the content item by incorporating corrections or enhancements suggested in the evaluation step. This ensures that the final output adheres more closely to the checklist criteria and any additional insights derived from the free-form comments. Once the content update is completed, the updated generated content item is stored in database 105.

Although not shown, the run-time evaluation process, in some implementations, may result in an update checklist request. If LLM 103 detects recurring issues or missing criteria in the evaluation checklist, it may update the checklist itself or generate a checklist update request to be sent to developer environment 107. After updating the checklist, developer environment 107 integrates the updated version into future evaluations. Subsequent user prompts would then utilize the revised checklist.

After the generated content item has been stored in database 105, developer environment 107 retrieves a set of generated content items for its own evaluation. Developer environment 107 submits the generated content items along with the current version of the evaluation checklist to LLM 103 for a structured assessment. LLM 103 evaluates each generated content item according to the predefined checklist questions to assess their quality. In addition to providing structured responses to the checklist questions, LLM 103 may generate free-form comments that highlight additional observations, such as recurring issues or gaps in the checklist criteria.

Upon receiving the evaluation responses from LLM 103, including the checklist answers and free-form comments, developer environment 107 initiates a checklist refinement process by sending an update checklist request to LLM 103. LLM 103 aggregates the free-form comments and analyzes them for recurring themes or new issues that are not adequately covered by the existing checklist. Based on this analysis, LLM 103 generates an updated evaluation checklist by adding new questions and/or removing existing questions that address previously unconsidered aspects of content evaluation. In other examples, updating the checklist may be performed manually via developer environment 107 based on the answers and comments received from LLM 103.

Once the updated checklist is received, developer environment 107 updates one or more user applications of user applications 101 with the revised checklist. This enables the user application(s) to incorporate the latest evaluation criteria when generating new responses, thereby improving the overall quality of responses provided to users.

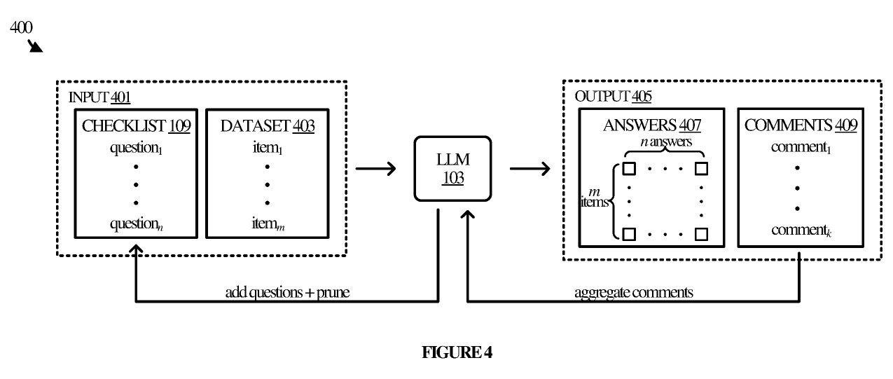

FIG. 4 illustrates evaluation framework 400 that is representative of a framework suitable for evaluating sets of generated content items in the context of a developer application as discussed with respect to the preceding Figures. Evaluation framework 400 includes input 401, LLM 103, and output 405. Input 401 includes checklist 109 and dataset 403. Output 405 includes answers 407 and comments 409. It may be appreciated that evaluation framework is a highly simplified representation of a suitable training framework whose purpose is to highlight certain aspects of the evaluation process and is not intended to exclude other functions or elements.

Input 401 represents the data structure provided to LLM 103 for performing an evaluation of the generated content items in dataset 403. Input 401 includes checklist 109, which contains a set of n structured evaluation questions designed to assess specific quality dimensions of generated content items, and dataset 403, which consists of m generated content items for evaluation. Dataset 403 may include various types of generated content items such as natural language explanations of spreadsheet formulas, procedural instructions, data analysis interpretations, or other content generated by an LLM.

LLM 103 processes input 401 by analyzing each of the m items against the n questions defined in checklist 109. This processing generates output 405, which has two distinct components: answers 407 and comments 409. Answers 407 represents a structured n×m matrix of discrete responses to each checklist question for each item in the dataset. These responses may take the form of Boolean values (e.g., yes/no), numerical ratings (e.g., 1-5 scale), or other predefined answer formats depending on the checklist’s configuration.

Comments 409 represents the unstructured free-form responses generated by LLM 103 when identifying aspects of the generated content items not adequately addressed by the existing checklist questions. The k comments illustrated in FIG. 4 correspond to instances where LLM 103 detected quality considerations or characteristic variations in the dataset not captured within the predefined evaluation criteria. These comments may provide feedback for checklist refinement by highlighting evaluation gaps, identifying emerging error patterns, or suggesting new quality dimensions for assessment.

The free-form responses may take various forms depending on the nature of the identified issues. These may include but are not limited to: (1) explanations that provide context or reasoning about why a particular aspect of the content represents a quality concern; (2) clarifications that elaborate on quality dimensions that might be difficult to capture in a binary or scaled response; and/or (3) critiques that specifically identify deficiencies, inconsistencies, or improvement opportunities in the generated content. Critiques may be particularly valuable for checklist evolution in some instances as they can highlight quality dimensions that were not anticipated during checklist design. For example, a critique may note that “while the formula explanation is technically accurate, it fails to acknowledge performance implications when applied to large datasets,” identifying an evaluation dimension (performance consideration) not captured in the original checklist questions.

After producing output 405, LLM 103 may further process and synthesize comments 409 to aggregate them and/or derive structured insights. To aggregate the comments, LLM 103 identifies recurring patterns, clusters similar observations, and generally transforms the unstructured feedback into formalized evaluation criteria. The aggregation process reduces redundancy by consolidating multiple related comments into cohesive evaluation dimensions. Specifically, the aggregation process may employ techniques such as semantic similarity detection to group conceptually related comments, frequency analysis to identify commonly occurring themes, contextual relevance assessment to prioritize domain-specific insights, and pattern recognition to detect emerging evaluation dimensions across multiple content items. This process results in the generation of multiple candidate evaluation questions that capture different aspects of the aggregated feedback. For example, if multiple free-form responses mention issues with terminology clarity, several candidate evaluation questions may be generated, such as “does the explanation define technical terms when first introduced?”, “is technical jargon minimized where possible?”, and “are complex concepts explained using accessible language?” These candidate evaluation questions represent potential additions to the evaluation checklist, from which the most relevant and broadly applicable questions may be selected for inclusion.

When aggregating multiple free-form responses from various content evaluations, the system specifically identifies recurring characteristics that appear consistently across different evaluation contexts. These recurring characteristics may manifest as similar observations about content quality, comparable suggestions for improvement, or consistent identification of missing evaluation dimensions. For example, if multiple free-form responses across different formula explanation evaluations mention insufficient explanation of parameter limitations, this may represent a recurring characteristic that indicates a systematic gap in the evaluation framework. In some examples, the identification of recurring characteristics may involve both frequency analysis (how often a particular observation appears) and similarity assessment (whether observations across different content items are conceptually related despite variations in specific wording or context).

In some embodiments, the aggregation and pruning operations utilize one or more meta-checklists—specialized evaluation criteria specifically designed to govern the checklist refinement process itself. When aggregating free-form comments into new evaluation questions, the system employs a meta-checklist that includes specific technical criteria: (1) avoidance of duplicate, redundant, or overlapping questions; (2) atomic property verification, where each question validates exactly one property; (3) elimination of subjective assessment dimensions; and (4) optimization for clarity and comprehensibility. Similarly, the pruning operation may employ a meta-checklist designed to identify and eliminate semantic equivalence between questions, maintain appropriate evaluation scope, and provide consistent question formats.

Following aggregation, LLM 103 adds questions to checklist 109 and/or prunes the questions from checklist 109 based on the processed and aggregated comments. In some implementations, this phase involves two operations: (1) expanding checklist 109 by incorporating new questions that address previously uncaptured quality dimensions, and (2) applying pruning techniques to maintain checklist manageability by removing redundant or low-value questions. The pruning operation prevents checklist bloat while maintaining comprehensive coverage of relevant evaluation criteria. The resulting updated checklist contains refined evaluation questions that more accurately and comprehensively assess the quality dimensions relevant to the specific domain of content generation being evaluated.

Updating and refining the evaluation checklists may occur through different operational modes depending on the specific implementation. In a fully automated mode, LLM 103 may directly implement checklist modifications without human intervention, streamlining the refinement process for rapid iteration. In a semi-automated mode, developer environment 107 may provide proposed checklist modifications for manual review by human reviewers for approval before implementation. In a collaborative mode, human developers may work interactively with LLM 103 through developer environment 107 to jointly craft new evaluation questions based on free-form response insights, leveraging both machine learning capabilities and human domain expertise. The specific operational mode may be configured based on factors including deployment context, quality assurance requirements, development workflow integration, and domain complexity. Regardless of operational mode, the underlying technical process maintains consistent functionality while adapting to varying levels of human oversight.

Thus, evaluation framework 400 implements a feedback loop that enables continual improvement of the evaluation criteria through systematic incorporation of LLM-generated insights. By capturing free-form observations beyond the structured checklist questions, the system progressively enhances its evaluation capabilities to address emergent quality considerations and domain-specific requirements.

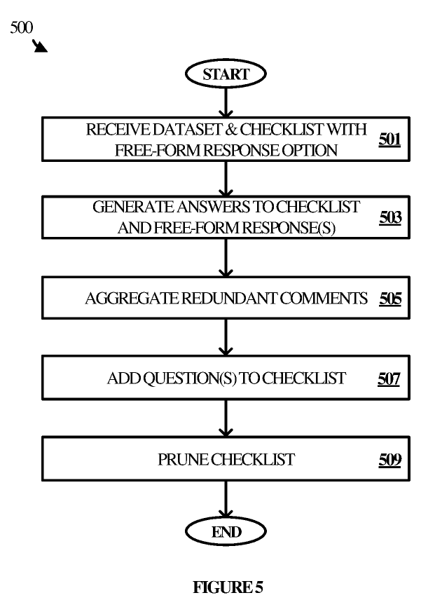

FIG. 5 illustrates process 500. Process 500 is an exemplary operation of dynamic checklist refinement for language model-based evaluation. The operations may vary in other examples. The operations of process 500, in some examples, are performed by a large language model, such as LLM 103 in the example of FIG. 1. The LLM operates on computing hardware including processors, memory, and other resources that host and execute the language model. While the physical computing infrastructure provides the computational substrate, the functional steps of process 500 represent operations performed by the LLM.

In operation, the LLM receives a dataset and a checklist with a free-form response option (step 501). The dataset includes multiple generated content items for evaluation, and the checklist includes predefined evaluation questions designed to assess various quality aspects of the generated content items. The free-form response option enables the LLM to provide additional feedback beyond the constraints of the predefined questions. In the example of FIG. 1, LLM 103 receives a dataset of generated content items and checklist 109 from developer environment 107.

The LLM generates answers to the checklist questions and free-form responses for the dataset (step 503). For each content item in the dataset, the LLM evaluates it against each question in the checklist, providing standardized answers in the format specified by the checklist (e.g., yes/no responses, numerical ratings, etc.). Additionally, the LLM generates one or more free-form responses that identify characteristics, issues, or considerations not addressed by the existing checklist questions. The LLM utilizes its contextual understanding capabilities to detect quality dimensions not explicitly covered by the predefined questions.

The LLM aggregates redundant comments from the free-form responses (step 505). This step involves the LLM analyzing the collection of free-form responses to identify recurring themes, patterns, or insights across multiple content items. The LLM groups semantically similar comments, consolidates overlapping observations, and identifies distinct evaluation dimensions that emerge from the unstructured feedback. This aggregation process transforms disparate observations into coherent evaluation criteria.

The LLM adds one or more questions to the checklist based on the aggregated comments (step 507). The LLM formulates new evaluation questions that capture the key insights or quality dimensions identified in the aggregated comments. These new questions address aspects of the generated content that were previously unevaluated by the existing checklist. The LLM ensures that newly formulated questions maintain consistency with the existing checklist structure and question formats.

The LLM prunes the checklist to remove redundant or low-value questions (step 509). This step involves the LLM reviewing the expanded checklist, which now includes both original questions and newly added questions, to identify and eliminate redundancies, overlap, or questions that do not provide significant discriminative value in the evaluation process. Pruning maintains the checklist’s manageability and efficiency while preserving comprehensive coverage of relevant quality dimensions.

Process 500, which includes receiving a dataset and checklist, generating answers and free-form responses, aggregating comments, adding questions to the checklist, and pruning the checklist, can be repeated iteratively to enable continual refinement of the evaluation framework. This iterative approach enables the checklist to evolve to comprehensively address emergent quality considerations and domain-specific requirements as more generated content is evaluated.

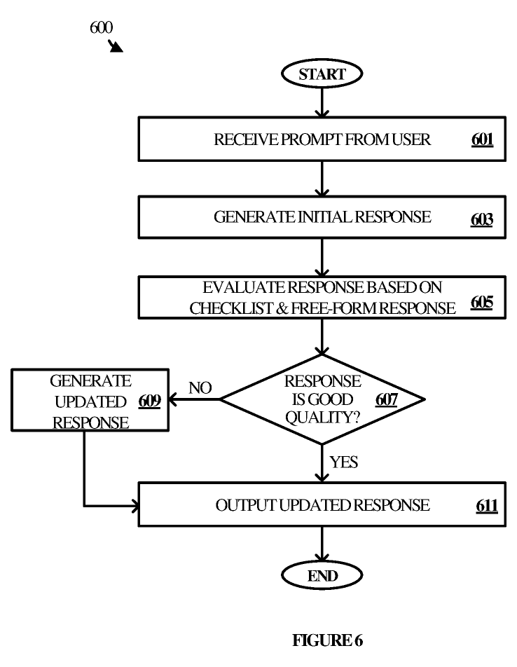

FIG. 6 illustrates process 600. Process 600 is an exemplary operation of runtime content evaluation and refinement performed by a language model in a user-facing scenario. The operations may vary in other examples. The operations of process 600, in some examples, are performed by a large language model, such as LLM 103 in the example of FIG. 1. LLM 103 operates on computing hardware including processors, memory, and other resources that host and execute the LLM. In this runtime scenario, the LLM evaluates and potentially refines its own responses before delivering them to end users.

In operation, the LLM receives a prompt from a user (step 601). The prompt contains a natural language query or request submitted through a user application such as a spreadsheet application interface, digital assistant, or other user-facing LLM platform. This prompt represents a real-time user interaction rather than a developer-initiated evaluation request. In the example of FIG. 1, LLM 103 receives the prompt from a user application of user applications 101.

The LLM generates an initial response to address the user’s prompt (step 603). The initial response applies the LLM’s knowledge and capabilities to generate content responsive to the user’s query. In a spreadsheet application context, this may include formula explanations, data analysis interpretations, procedural guidance, or other content relevant to the user’s request. The generation process utilizes the LLM’s parameters and training data to produce content deemed most responsive to the user’s needs.

The LLM evaluates the response based on a checklist with free-form response option (step 605). The LLM applies an evaluation checklist that contains predefined quality criteria to assess its own generated content. The checklist includes dimensions such as accuracy, relevance, completeness, clarity, and domain-specific considerations relevant to the application context. Additionally, the free-form response option allows the LLM to identify quality considerations not explicitly addressed by existing checklist items.

The LLM determines whether the response is of good quality (decision point 607). Based on the evaluation results from step 605, the LLM analyzes whether the initial response satisfies predefined quality criteria. This determination may involve assessing the evaluation outcomes against established thresholds or rules that define acceptable quality levels. If the response meets or exceeds these thresholds, the process proceeds along to step 611. If quality deficiencies are identified, the process proceeds to step 609.

If quality deficiencies are identified, the LLM generates an updated response (step 609). The LLM modifies the initial response to address any specific issues identified during the evaluation process. This refinement may incorporate feedback from both the structured checklist assessment and any free-form observations generated during step 605. The LLM may clarify ambiguous explanations, correct inaccuracies, add missing information, improve formatting, or enhance other aspects of the content to address identified deficiencies.

The LLM outputs the final response to the user (step 611). The LLM delivers either the original response (if it met quality thresholds) or the updated response (if refinement was necessary) to the user through the user application interface. This output represents the culmination of the generation and quality control process, providing content that has undergone internal evaluation against established quality criteria. In the example of FIG. 1, LLM 103 transmits the final response to one or more user applications of user applications 101 for presentation to the user.

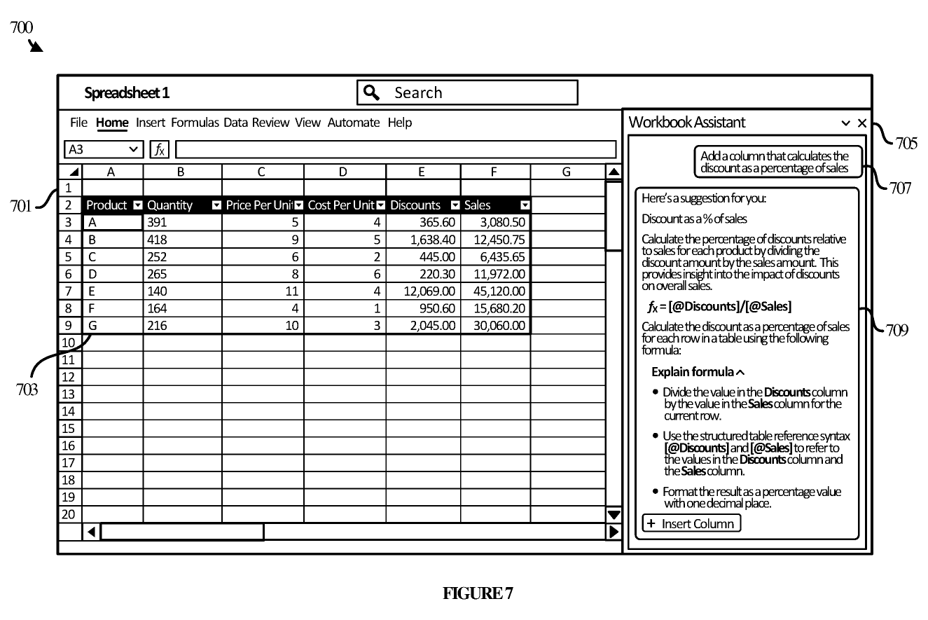

FIG. 7 illustrates user interface 700. User interface 700 is an exemplary representation of a spreadsheet application environment demonstrating components relevant to the generation and evaluation of content items. The spreadsheet application of FIG. 7 is representative of a user application that may be included in user applications 101 from the preceding Figures. The elements shown may vary in other implementations. User interface 700 includes spreadsheet 701, table 703, and workbook assistant 705. Workbook assistant includes prompt 707 and response 709.

Spreadsheet 701 represents the primary workspace of the spreadsheet application, displaying a grid-based interface where users manipulate data, formulas, and calculations. Spreadsheet 701 contains structured data arranged in rows and columns, with specific cells containing numerical values, text entries, and formulas. In this example, spreadsheet 701 displays financial data including product information, quantities, prices, discounts, and sales figures across multiple columns.

Table 703 represents a formatted data structure within spreadsheet 701, displaying information in a structured tabular format with defined columns for Product, Quantity, Price Per Unit, Discounts, and Sales. Table 703 enables organized data presentation and simplified reference mechanisms for analysis operations. The structured nature of table 703 provides context for the user’s query and the subsequent generated content.

Workbook assistant 705 represents an AI-powered interface component that facilitates natural language interaction between the user and the spreadsheet application. Workbook assistant 705 contains prompt 707, which records the user’s natural language query requesting functionality related to the spreadsheet (“Add a column that calculates the discount as a percentage of sales”), and response 709, which contains the AI-generated explanation of a formula implementation addressing the user’s request.

Response 709 represents a generated content item produced by an LLM in response to prompt 707. Response 709 includes multiple components: a formula recommendation (“=[@Discounts]/[@Sales]”), a descriptive title (“Calculate the discount as a percentage of sales for each row”), and a detailed explanation of the formula’s function and implementation considerations. This explanation breaks down the computational logic, explains the structured reference syntax, and provides formatting guidance. Response 709 exemplifies the type of natural language content that would be evaluated using the checklist-based assessment methodology described in reference to the preceding Figures.

In some implementations, only response 709 is stored as a generated content item for subsequent evaluation using the checklist methodology described herein. This approach focuses quality assessment specifically on the AI-generated explanatory content. In other implementations, both prompt 707 and response 709 may be stored together as a single generated content item to provide contextual information for evaluation, or they may be stored separately but with relational linkages maintained for contextual reference during evaluation.

While FIG. 7 depicts a spreadsheet application interface, the technology disclosed herein applies to diverse environments and content types beyond spreadsheet applications. Generated content items suitable for checklist-based evaluation may include natural language responses in conversational AI platforms, technical documentation generated by language models, medical report summaries, legal document analyses, code explanations, educational content, customer service responses, creative writing outputs, translation results, data visualization narratives, and more. The evaluation methodology applies across varied domains including productivity applications, healthcare information systems, legal technology platforms, software development environments, educational technology platforms, e-commerce systems, entertainment content generators, and more.

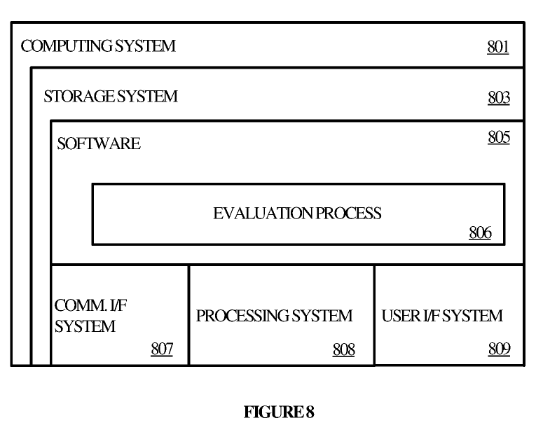

FIG. 8 illustrates computing device 801 that is representative of any computing apparatus or collection of devices on which the various processes, programs, services, and scenarios disclosed herein may be implemented. Examples of computing device 801 include, but are not limited to, server computers, desktop and laptop computers, tablet computers, mobile phones, audio devices, wearable devices (e.g., headphones, ear buds, eyeglasses, and wrist watches), industrial computers, microcontroller units (MCUs), Internet of Things (IoT) devices, and the like.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements evaluation process 806, which is representative of the processing methods and processes described above including but not limited to process 200, process 500, and process 600. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may include a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units (CPUs), graphical processing units (GPUs), neural processing units (NPUs), digital signal processors (DSPs), application specific integrated circuits (ASICs), and logic devices, as well as any other type of processing device, circuitry, or combinations and variations thereof.

Storage system 803 may include any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may include additional elements, such as a controller, capable of communicating with processing system 802 or possibly other systems.

Software 805 (including evaluation process 806) may be implemented in program instructions and among other functions may, when executed by processing system 802, direct processing system 802 to operate as described with respect to the various operational scenarios, sequences, and processes illustrated herein. For example, software 805 may include program instructions for implementing the evaluation of generated content items as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software (including virtual machine software and container software), or other such application software. Software 805 may also include firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to perform content generation, content evaluation, checklist storage, and/or checklist updating processes as described herein. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the disclosed technology may be embodied as a system, method, or computer program product. Accordingly, aspects of the technology may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the technology disclosed herein may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method comprising:
by one or more computing devices:
generating a prompt comprising an evaluation checklist and a generated content item, wherein the evaluation checklist comprises predefined evaluation questions for a language model to answer with respect to the generated content item and an option for the language model to generate a free-form response in addition to answering the predefined evaluation questions;
sending the prompt to the language model to obtain an evaluation of the generated content item based on the evaluation checklist;
receiving a response from the language model, wherein the response includes answers to the predefined evaluation questions and at least one free-form response indicating a characteristic of the generated content item; and
updating the evaluation checklist with a new evaluation question based at least on the at least one free-form response.

2. The method of claim 1, wherein:
the generated content item comprises a natural language response generated by the language model in response to a prior prompt, the prior prompt comprising a query related to a data analysis operation in a spreadsheet application; and
the predefined evaluation questions correspond to aspects of the natural language response.

3. The method of claim 2, wherein the natural language response comprises at least one of a natural language explanation of a spreadsheet formula and a natural language explanation of a result of the data analysis operation in the spreadsheet application.

4. The method of claim 2, wherein:
sending the prompt comprises a developer application sending the prompt to the language model;
updating the evaluation checklist comprises the developer application updating the evaluation checklist; and
the developer application obtains the generated content item from the spreadsheet application.

5. The method of claim 1, wherein the generating the prompt, sending the prompt, receiving the response, and updating the evaluation checklist occurs iteratively.

6. The method of claim 1, further comprising aggregating multiple free-form responses, including the at least one free-form response, from multiple evaluations by the language model to identify recurring characteristics among the multiple free-form responses and generating the new evaluation question based on the recurring characteristics.

7. The method of claim 6, wherein generating the new evaluation question comprises generating multiple candidate evaluation questions based on the multiple free-form responses and selecting the new evaluation question from the multiple candidate evaluation questions.

8. The method of claim 1, wherein:
the at least one free-form response corresponds to an aspect of the generated content item that is not addressed by the predefined evaluation questions; and
the at least one free-form response comprises at least one of an explanation, a clarification, and a critique of the generated content item.

9. One or more computer readable storage media having program instructions stored thereon that, when executed by one or more processors of a computing apparatus, direct the computing apparatus to at least, iteratively:
generate a prompt comprising an evaluation checklist and a generated content item, wherein the evaluation checklist comprises predefined evaluation questions for a language model to answer with respect to the generated content item and an option for the language model to generate a free-form response in addition to answering the predefined evaluation questions;
send the prompt to the language model to obtain an evaluation of the generated content item based on the evaluation checklist;
receive a response from the language model, wherein the response includes answers to the predefined evaluation questions and at least one free-form response indicating a characteristic of the generated content item; and
update the evaluation checklist with a new evaluation question based at least on the at least one free-form response.

10. The one or more computer readable storage media of claim 9, wherein:
the generated content item comprises a natural language response generated by the language model in response to a prior prompt, the prior prompt comprising a query related to a data analysis operation in a spreadsheet application; and
the predefined evaluation questions correspond to aspects of the natural language response.

11. The one or more computer readable storage media of claim 10, wherein the natural language response comprises at least one of a natural language explanation of a spreadsheet formula and a natural language explanation of a result of the data analysis operation in the spreadsheet application.

12. The one or more computer readable storage media of claim 10, wherein:
the program instructions, to send the prompt, direct the computing apparatus to send the prompt to the language model via a developer application;
the program instructions, to update the evaluation checklist, direct the computing apparatus to update the evaluation checklist via a developer application; and
the developer application obtains the generated content item from the spreadsheet application.

13. The one or more computer readable storage media of claim 12, wherein the program instructions further direct the computing apparatus to format the response for display and enable display of the response in a user interface of the developer application.

14. The one or more computer readable storage media of claim 9, wherein the program instructions further direct the computing apparatus to aggregate multiple free-form responses, including the at least one free-form response, from multiple evaluations by the language model to identify recurring characteristics among the multiple free-form responses and generate the new evaluation question based on the recurring characteristics.

15. The one or more computer readable storage media of claim 14, wherein the program instructions, to generate the new evaluation question, direct the computing apparatus to generate multiple candidate evaluation questions based on the multiple free-form responses and select the new evaluation question from the multiple candidate evaluation questions.

16. The one or more computer readable storage media of claim 9, wherein:
the at least one free-form response corresponds to an aspect of the generated content item that is not addressed by the predefined evaluation questions; and
the at least one free-form response comprises at least one of an explanation, a clarification, and a critique of the generated content item.

17. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
generate a prompt comprising an evaluation checklist and a generated content item, wherein:
the evaluation checklist comprises predefined evaluation questions for a language model to answer with respect to the generated content item and an option for the language model to generate a free-form response in addition to answering the predefined evaluation questions; and
the generated content item comprises a natural language response generated by the language model in response to a prior prompt comprising a query related to a use case in a spreadsheet application;
send the prompt to the language model to obtain an evaluation of the generated content item based on the evaluation checklist;
receive a response from the language model, wherein the response includes answers to the predefined evaluation questions and at least one free-form response indicating a characteristic of the generated content item; and
update the evaluation checklist with a new evaluation question based at least on the at least one free-form response.

18. The computing apparatus of claim 17, wherein:
the predefined evaluation questions relate to aspects of the natural language response; and
the at least one free-form response corresponds to an aspect of the generated content item that is not addressed by the predefined evaluation questions.

19. The computing apparatus of claim 17, wherein the natural language response comprises at least one of a natural language explanation of a spreadsheet formula and a natural language explanation of a data analysis result in the spreadsheet application.

20. The computing apparatus of claim 17, wherein the program instructions further direct the computing apparatus to aggregate multiple free-form responses, including the at least one free-form response, from multiple evaluations by the language model to identify recurring characteristics among the multiple free-form responses and generate the new evaluation question based on the recurring characteristics.
